(19) United States
(12) Patent Application Publication
(10) Pub. No.: US 2022/0068297 A1
(43) Pub. Date: Mar. 3, 2022

(54) AUDIO LEVEL ESTIMATOR ASSISTED FALSE AWAKE ABATEMENT SYSTEMS AND METHODS

(71) Applicant: Knowles Electronics, LLC, Itasca, IL (US)

(72) Inventors: Ketul Patel, Itasca, IL (US); Casey Ng, Itasca, IL (US); Edward Chang, Itasca, IL (US)

(21) Appl. No.: 17/415,594

(22) PCT Filed: Dec. 16, 2019
(86) PCT No.: PCT/US2019/066504

§ 371 Date: Jun. 17, 2021

Related U.S. Application Data
(60) Provisional application No. 62/781,423, filed on Dec. 18, 2018.

(51) Int. Cl. G10L 25/78; G10L 15/08

(52) U.S. Cl. CPC G10L 25/78; G10L 2015/088; G10L 2025/783; G10L 15/08

(57) ABSTRACT

A system and method provides for false wake abatement. For instance, an audio energy detection controller opens a keyword detection window in response to a detected audio input level reaching a threshold and a keyword detector detects a keyword in response to a detected audio input corresponding to a keyword signature. In response to both a keyword being detected and the detected audio input level indicating a near field source of the speech, a device may be triggered to awaken. In this manner, the incidence of false awakenings due to keywords spoken by proximate third parties is ameliorated.

### CROSS-REFERENCE TO RELATED APPLICATIONS

This application claims the benefit of and priority to U.S. Provisional Patent Application No. 62/781,423, filed Dec. 18, 2018, the entire contents of which are incorporated herein by reference.

### TECHNICAL FIELD

This application relates generally to audio processing and more particularly to systems and methods for false wake abatement.

### BACKGROUND

A voice controlled user interface may activate in response to a user speaking a keyword. However, the user may utilize the voice controlled user interface in a variety of different contexts, including contexts with background noise. The background noise may include speech from other people, electronic noises from speakers, reproduced speech from televisions, radios, and other devices, and may vary in duration, amplitude, impulse, and other characteristics from time to time. Moreover, the keyword may also be a component of the background noise, as other speakers in the area surrounding the user may also speak the keyword, such as to address their own voice controlled user interfaces or for other purposes. Thus there remain challenges associated with distinguishing sounds associated with voice control inputs of a user from other sounds.

In various instances, the voice controlled user interface is operable in connection with a mobile device. The interface may be operable to transition the device from a low power (sleeping) mode to an operational (full) mode in response to a voice command. One difficulty in using voice to wake up a device is false detection of the voice command. The false detection can cause activation of a processor, display, or other high power system of a device. This could lead to unwanted reduction in the mobile device's battery charge. In addition, false wakeup is annoying to users because a voice prompt or other sound indicating that the wakeup has occurred may be generated.

### BRIEF DESCRIPTION OF THE DRAWINGS

For a more complete understanding of the disclosure, reference should be made to the following detailed description and accompanying drawings wherein:

FIG. 1 depicts an example audio device including a host device and an audio input device with an audio level estimator assisted false wake abatement system therein, in accordance with various embodiments;

FIG. 2 depicts an example audio level estimator assisted false wake abatement system with an audio energy detection controller and a keyword detector module, in accordance with various embodiments;

FIG. 3 illustrates one example implementation of an audio energy detection controller, in accordance with various embodiments;

FIG. 4 illustrates a truth table depicting different states of the audio level estimator assisted false wake abatement system and associated values of an event detection logic output of the system, in accordance with various embodiments; and

FIG. 5 illustrates a flow chart depicting a method of false wake abatement including parallel processes of (i) an audio energy detection controller and (ii) a keyword detector module, in accordance with various embodiments.

### SUMMARY

A method of false wake abatement is provided. The method may include receiving, by an audio energy detection controller and a keyword detector, an input audio signal. Moreover, the method may include measuring, by an input audio energy (IAE) measurement unit of the audio energy detection controller, an input audio energy of each of a plurality of samples of the input audio signal. The IAE measurement unit may generate a weighted energy value corresponding to the measured input audio energy of the plurality of samples and may compare the weighted energy value to an IAE value threshold. In response to the weighted energy value exceeding the IAE value threshold, the IAE comparison engine may direct a window status reporting module to set a window status flag of a flag memory. The method may contemplate detecting, by the keyword detector, a presence of a keyword contained in the input audio signal. In addition, the method may include triggering by the keyword detector, a keyword presence interrupt of a detection event reporter, responsive to the detecting the presence of the keyword, to indicate the detecting the presence of the keyword. The method may include retrieving, by the detection event reporter, the window status flag of the flag memory responsive to the triggering of the keyword presence interrupt. The method may include accessing, by the detection event reporter, the retrieved window status flag in response to the triggering of the keyword presence interrupt, and may include reporting, by a detection event reporter, the presence of the keyword in response to the keyword presence interrupt being triggered and the window status flag being set.

The method may also include, counting, by a trigger frames counter of the audio energy detection controller, a number of the plurality of samples of the input audio signal. A frame clock may generate a clock signal including a series of clock cycles, wherein one or more of the plurality of samples of the input audio signal correspond to an individual clock cycle of the series of clock cycles. The generating of the weighted energy value may be responsive to the trigger frames counter of the audio energy detection controller indicating that the number of the plurality of samples of the input audio signal at least equals a configurable trigger frames target.

In various embodiments a frame clock generates a clock signal including a series of clock cycles. The method may include incrementing, by a window frames counter of the audio energy detection controller, a window frames index, wherein each of the increments of the window frames counter of the audio energy detection controller correspond in time to an individual clock cycle of the series of clock cycles. The method may also include determining, by the window frames counter of the audio energy detection controller that the window frames index equals a configurable window length target, and in response to the window frames index equaling the configurable window length target, unsetting the window status flag of the flag memory.

In various embodiments the detecting, by the keyword detector, the presence of the keyword includes steps of (i) detecting an audio signature of a plurality of samples of the input audio, (ii) comparing the audio signature to a known keyword signature set, and (iii) determining that the audio signature of the plurality of samples of the input audio corresponds to at least one known keyword signature of the known keyword signature set.

The measuring, by the input audio energy (IAE) measurement unit of the audio energy detection controller, the input audio energy of each of the plurality of samples of the input audio signal may occur at least partially simultaneously and/or in parallel with the detecting, by the keyword detector the presence of the keyword contained in the input audio signal. The audio energy detection controller and the keyboard detector may be components of a smart microphone device. Finally, the reporting, by the detection event reporter, may include sending an activation signal to a personal electronic device to end a sleep mode of the personal electronic device.

A non-transient computer readable medium containing program instructions is provided. The computer instructions may be for causing a computer to perform a method of false wake abatement as discussed above.

A system for false wake abatement is provided. The system may include an audio energy detection controller connected to an audio input and configured to receive an input audio signal from the audio input and store a window status flag in a flag memory in response to the input audio signal. The system may include a keyword detector connected to the audio input and configured to receive the input audio signal from the audio input and to receive a window status flag from a flag memory and connected to a detection event reporter configured to indicate on an event detection logic output a presence of a keyword. The detection event reporter may be connected to the flag memory and the keyword detector.

Continuing with reference to the system having an audio energy detection controller and a keyword detector and a detection event reporter, the audio energy detection controller may have an input audio energy (IAE) measurement unit configured to measure an input audio energy of each of a plurality of samples of the input audio signal and configured to generate a weighted energy value corresponding to the measured input audio energy of the plurality of samples. The audio energy detection controller may have an IAE comparison engine configured to compare the weighted energy value to an IAE value threshold. In response to the weighted energy value exceeding the IAE value threshold, the IAE comparison engine directs a window status reporting module to set a window status flag of a flag memory.

The keyword detector may detect a presence of a keyword contained in the input audio signal and trigger a keyword presence interrupt of the detection event reporter, responsive to the detecting the presence of the keyword, to indicate the detecting the presence of the keyword. The detection event reporter may be configured to access the window status flag in response to the triggering the keyword presence interrupt. The detection event reporter may be configured to report the presence of the keyword in response to the keyword presence flag being set and the window status interrupt being triggered.

The audio energy detection controller of the controller may have various features such as a trigger frames counter and a frame clock. A trigger frames counter may be configured to count a number of the plurality of samples of the input audio signal. A frame clock may be configured to generate a clock signal including a series of clock cycles, wherein one or more of the plurality of samples of the input audio signal correspond to an individual clock cycle of the series of clock cycles. The generating the weighted energy value is responsive to the trigger frames counter of the audio energy detection controller indicating that the number of the plurality of samples of the input audio signal at least equals a configurable trigger frames target.

In various embodiments, the audio energy detection controller further includes a frame clock and a window frames counter. The frame clock may be configured to generate a clock signal including a series of clock cycles. The window frames counter may be configured to increment a window frames index, wherein each of the increments of the window frames counter correspond in time to an individual clock cycle of the series of clock cycles. In various embodiments, the window frames counter is further configured to determine that the window frames index equals a configurable window length target. In response to the window frames index equaling the configurable window length target, the window status flag of the flag memory is unset.

In various embodiments, the keyword detector detects the presence of the keyword by at least (i) detecting an audio signature of a plurality of samples of the input audio, (ii) comparing the audio signature to a known keyword signature set, and (iii) determining that the audio signature of the plurality of samples of the input audio corresponds to at least one known keyword signature of the known keyword signature set.

Moreover, the input audio energy (IAE) measurement unit of the audio energy detection controller may measure the input audio energy of each of the plurality of samples of the input audio signal at least partially simultaneously and/or in parallel with the keyword detector detecting the presence of the keyword contained in the input audio signal.

Finally, the detection event reporter may send an activation signal to a personal electronic device to end a sleep mode of the personal electronic device.

### DETAILED DESCRIPTION

Skilled artisans will appreciate that elements in the figures are illustrated for simplicity and clarity. It will further be appreciated that certain actions, blocks, and/or steps may be described or depicted in a particular order of occurrence while those skilled in the art will understand that such specificity with respect to sequence is not actually required. It will also be understood that the terms and expressions used herein have the ordinary meaning as is accorded to such terms and expressions with respect to their corresponding respective areas of inquiry and study except where specific meanings have otherwise been set forth herein.

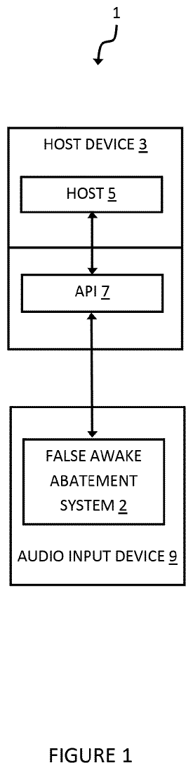

According to certain general aspects, the present embodiments are directed to systems and methods for false wake abatement. An audio level estimator may be implemented to facilitate the abatement of false awakenings. Referring to FIG. 1, a voice activated user interface is utilized by a user with an audio input device 9 near to the user's mouth, in a user's ear, or otherwise on the user's person (a “close talk device”). However, the close talk device also detects sounds from surrounding sources other than the user. These challenges are even more pronounced when the audio input device 9 is a single microphone, because of the limited ability to implement noise suppression and/or beam forming techniques in a single microphone device. An audio level estimator assisted false wake abatement system 2 may be incorporated into the audio input device 9 to address these challenges. For brevity, the system will be referred to as a false wake abatement system 2.

As discussed herein, typically a speech-to-noise ratio (SNR) of a user's speech input to a close talk device is sufficiently great that the user's speech exhibits greater detected amplitude and/or energy than the other surrounding sounds that may contribute to a false awakening scenario. For instance, a user may speak a keyword into the close talk device (audio input device 9) or another person near the user may speak a keyword. However, systems and methods provided herein distinguish between the keyword spoken by the user and a keyword spoken by another party and may ameliorate the instance of unwanted device responses to the keyword spoken by another party. The system 2 provided herein distinguishes between user speech and other sounds/speech. One aspect of the system 2 to make this distinction arises from a determination that the SNR of user speech is, in various embodiments, significant (as mentioned) in contrast to an SNR of background noise. For instance, user speech may have a speech-to-noise ratio that is greater than a threshold value that differentiates user speech and background noise. For instance, user speech may have a signal-to-noise ration that is greater than 6 dB. Moreover, in various instances, distinction between user speech and other sounds/speech arises from a determination that the sound is at an amplitude greater than 68 dBA and thus is likely user speech, though other scenarios are possible.

Thus, by calculating the energy of an incoming audio signal, it may be determined whether the audio is originating from a near field (e.g., a user) or a far field (e.g., the surrounding environment). When a keyword utterance is detected, and the audio sample energy level is higher than a threshold, then the system 2 may determine that the keyword is present and the present keyword was uttered by the user, and not by another agent in the surrounding environment, such as another person, a television, and/or the like. Action may then be taken based on the instruction associated with keyword inputted by the user. For example, the audio input device 9 (and specifically, the false wake abatement system 2 of the audio input device 9) may send a keyword detection and/or activation signal to an API 7 of a host device 3, so that a host 5 running in the host device 3 takes a responsive action based on the instructions associated with keyword inputted by the user.

Other mechanisms have included training a system or method with many keyword models spoken differently by different users. However, by isolating near field and far field inputs, an entire category of audio inputs (e.g., sounds originating in a far field) may be categorically ignored, thereby reducing computational load and model complexity and proliferation.

Moreover, as will be seen further herein, the reliability of the correct identification of near field and far field inputs can be enhanced through a frame-based architecture. As used herein, “frame” may also refer to one more “samples,” or in other contexts “clock cycle.” For instance, the system 2 may have a clock. The false wake abatement system 2 may include this clock. In other instances, the clock signal may be externally provided. The system 2 may take action based on an evaluation of multiple discrete data samples, rather than a single sample. These samples may be collected in connection with cycles of the clock. For example, one or more samples may be taken periodically, and a periodic clock may facilitate timing and counting of the samples.

The utilization of multiple samples rather than a single sample may facilitate improved reliability. For instance, rather than determining that an instantaneous audio input has an amplitude, signal-to-noise ratio, and/or energy associated with audio originating from the user (e.g., a near field input), instead, the system 2 may look at a set of multiple samples collected over multiple clock cycles. The multiple clock cycles may be termed a “sampling window.” The system 2 may determine whether the audio input over time continues to have an amplitude, signal-to-noise ratio, and/or energy associated with audio originating from the user (e.g., a near field input) by sampling over a period of time rather than at a single instant. Multiple samples may be spaced apart in time and collected.

The system 2 may average the amplitude and/or energy associated with the audio among multiple samples of the sampling window, and may provide a binary flag in response to the averaged amplitude and/or energy exceeding a threshold. Exceeding the threshold may activate a timer. During the period of the timer, any detected keyword is presumed to originate in the near field and thus from the user. The period of the timer is called a configurable detection window. Thus, exceeding the threshold may mark the start of a configurable keyword detection window that lasts for a number of clock cycles corresponding to the period of the timer. This configurable keyword detection window is a period of time during which any detected keyword is presumed to originate in the near field and thus from the user.

A later instance of again exceeding the threshold may cause the timer to reset so that the configurable keyword detection window is always extending forward in time from the last instance of exceeding the threshold. Thus the configurable keyword detection window may be said to be a “sliding configurable keyword detection window” because it slides forward in time when retriggered. In this manner, a user who initially speaks loudly but then speaks very softly will be more frequently properly identified as a near field input.

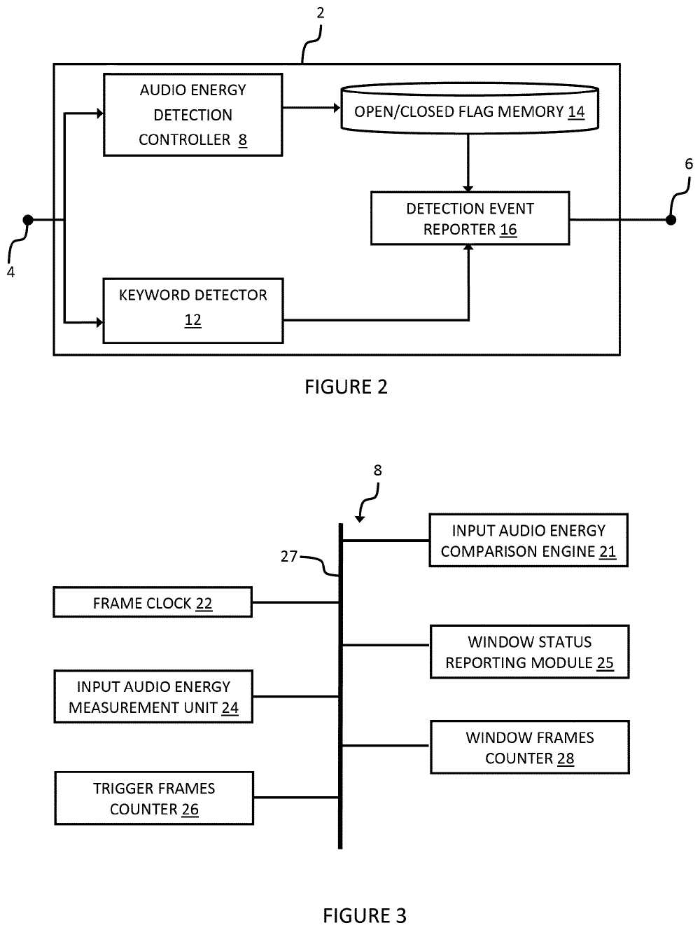

In various instances, the method may include three generalized steps. For instance, in step one, a host 5 configures required parameters. These parameters may be preset or may be dynamic. The parameters may be configured by the host 5 via the API 7, though any other mechanism may be contemplated. These parameters may include (i) a flag to enable or disable the false awake abatement system 2 to distinguish near and far field inputs, (ii) the threshold value that triggers the distinction between near and far field inputs, (iii) the number of frames that make up the sampling window, and (iv) the number of frames that make up the configurable keyword detection window. In step two, an audio energy detection controller 8 (FIG. 2) of the false awake abatement system 2 calculates an energy of incoming audio sample(s) and opens the configurable keyword detection window upon determining that the energy exceeds a threshold. In step three, a keyword detector 12 (FIG. 2) of the false wake abatement system 2 detects any keyword utterance detected in incoming audio sample(s). Steps two and three may occur at least partially simultaneously and/or in parallel. If the sampling keyword window is open and the keyword utterance is detected, then a detection event reporter 16 may generate an indication that may be passed to other systems and devices to take action responsive to the keyword. For instance, the audio input device 9 having the false wake abatement system 2 may send a keyword detection and/or activation signal to an API 7 of a host device 3 so that a host 5 of the host device 3 takes a responsive action.

With specific emphasis on a non-limiting embodiment of the FIG. 1 audio device 1, a host device 3 may comprise a smartphone, a laptop, a tablet, or another electronic device. The host 5 of the host device may be a software application and/or a processor executing software instructions from a memory. The host 5 may communicate via an API 7 with an audio input device 9. The audio input device 9 may comprise a smart microphone (i.e. a single module incorporating both a microphone and a processor such as an ASIC and/or a DSP). The smart microphone may include a false wake abatement system 2 (e.g., implemented by the processor and associated firmware). Thus one may appreciate that a host device 3 (smartphone) may enter a low power and/or sleep state to conserve battery life. The audio input device 9 (smart microphone) may awaken the host device 3 and cause it to return to a higher power and/or non-sleep state via a signal sent to the API 7 from the false wake abatement system 2. For instance, a smartphone may enter a sleep state until a smart microphone causes the smartphone to awaken from the sleep state. The smart microphone may cause this awakening in response to a detection event associated with the false wake abatement system 2, such as detection of a spoken keyword uttered by a user of the audio device 1.

In FIG. 2, an example embodiment of a false wake abatement system 2 is depicted. A false wake abatement system 2 may include an audio input 4 to receive a signal representing audio. The audio input 4 is operatively coupled to an audio energy detection controller 8 and a keyword detector 12.

The false wake abatement system 2 includes an audio energy detection controller 8. The audio energy detection controller 8 is configured to selectively open and close a sampling window for the keyword detector 12. The audio energy detection controller 8 may use a threshold to determine the distinction between near and far field inputs. The audio energy detection controller 8 determines whether a speech-to-noise ratio (SNR) of speech input to a close talk device is sufficiently great that the speech exhibits significantly greater detected amplitude and/or energy than other surrounding sounds so that the speech input is a user's speech. The audio energy detection controller 8 thus distinguishes between speech of the user and other sounds. The audio energy detection controller 8 may distinguish between near field sources and far field sources of sound and indicate to which category a received sound at the audio input 4 corresponds. The audio energy detection controller 8 takes multiple samples of the audio provided by the audio input 4 and compares the samples to a threshold. The audio energy detection controller 8 may compute an average amplitude of the samples. In further instances, the audio energy detection controller 8 computes an average energy of the samples. This average energy value is compared by the audio energy detection controller 8 to a threshold. If the average energy value exceeds the threshold, the audio energy detection controller 8 determines that the associated audio is a near field sources such as the user's speech. If the value does not exceed the threshold, the audio energy detection controller 8 determines that the associated audio is not a near field source, for example, it may be a far field source such as a third party or a television, or another source other than the user. The audio energy detection controller 8 may also set a window status flag when it determines that the audio is a near field source. The audio energy detection controller 8 may hold this window status flag in a set condition for a period of time. After the set period of time, the audio energy detection controller 8 may unset the window status flag. The period of time may be restarted if user speech is detected again while the window status flag is in a set condition (e.g., if subsequent indications of audio sourced by a near field source are determined). In this manner a configurable keyword detection window associated with the period of time may be a sliding window that slides so that the window status flag stays set for the period of time following the last detection of audio sourced by a near field source.

The window status flag set and unset by the audio energy detection controller 8 is stored in a flag memory 14 of the false wake abatement system 2. The flag memory 14 comprises at least one electronic memory register, logic gate, or other storage mechanism configured to receive data from the audio energy detection controller 8 comprising the setting and unsetting of the window status flag corresponding to whether the configurable keyword detection window is open or closed. During periods that the window status flag is in a set state, the configurable keyword detection window is open. During periods that the window status flag is in an unset state, the configurable keyword detection window is closed. An open status corresponds to the receipt of a near field sound within the period of time mentioned previously. The flag memory 14 is further configured to receive a connection from the detection event reporter 16. The detection event reporter 16 reads this window status flag from the flag memory 14.

The false wake abatement system comprises a keyword detector 12 that operates at least partially in parallel with audio energy detection controller 8. The keyword detector 12 may analyze audio provided by the audio input 4 and may determine whether the audio contains a keyword. For example, a keyword may comprise a spoken phrase and/or a tone. For instance, a keyword may include “Alexa” or “Siri” or “Hey Google.” The keyword detector 12 may trigger a keyword presence interrupt corresponding to whether a keyword is detected. The keyword presence interrupt may be caught by the detection event reporter 16 which may take responsive action. The keyword detector 12 may indicate to a detection event reporter 16 that a keyword is present via the throwing and catching of the keyword presence interrupt.

The false wake abatement system comprises a detection event reporter 16. The detection event reporter 16 may be connected to both the flag memory 14 and the keyword detector 12. The detection event reporter 16 may provide, at an event detection logic output 6, a binary state corresponding to the logical “AND” combination of the window status flag and the keyword presence interrupt. Thus, one may appreciate that the false wake abatement system 2 provides an “awake” indication corresponding to both the presence of the keyword and the keyword having been detected within the sampling window. By only indicating an “awake” indication when the keyword is a near field sound or is temporally proximate to a near field sound, the likelihood that the keyword is generated by a near field source is enhanced and false awakenings due to non-near field sourced sounds are diminished.

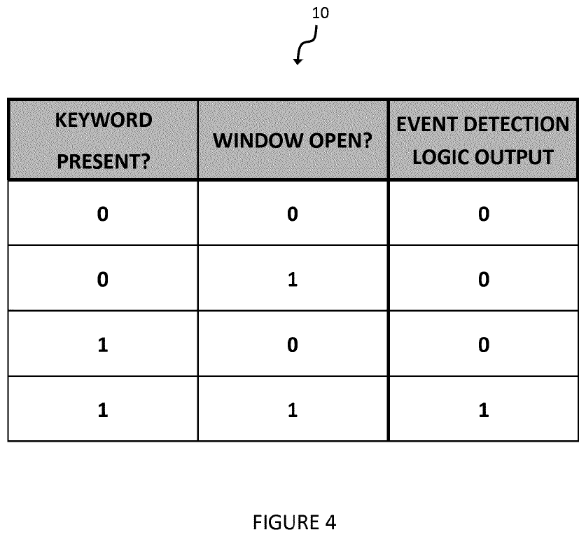

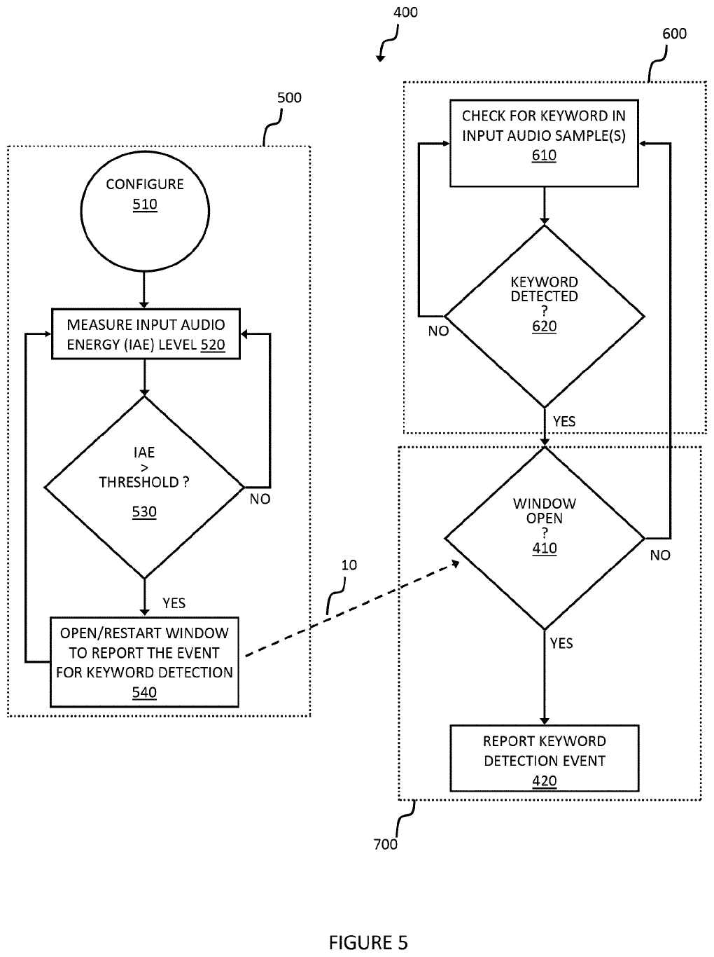

In FIGS. 2 and 4, an example event detection logic output truth table 14 is shown. As mentioned, the detection event reporter 16 may indicate at an event detection logic output 6 a binary state corresponding to the logical “AND” combination of the keyword presence interrupt and the window status flag. Thus, only keywords present during an open configurable keyword detection window drive a state change of the event detection logical output 6 corresponding to a detected keyword. As a result, keyword utterances that originate from a source other than the user are ignored because they are not associated with an open configurable keyword detection window.

Having discussed the audio energy detection controller 8, the keyword detector 12, and the detection event reporter 16 generally, FIG. 2 and provide a detailed discussion of the audio energy detection controller 8. An audio energy detection controller 8 may have various components interconnected on an audio energy detection controller bus 27. The audio energy detection controller bus 27 may be a logical bus corresponding to internal operative interconnections of the components. In further instances, the audio energy detection controller bus 27 may be a physical bus. Moreover, the components to be discussed in greater detail below may be depicted as logically distinct components herein for ease of reference. However, the logical components may be combined in various other arrangements.

The audio energy detection controller 8 may comprise a frame clock 22. A frame clock 22 may comprise an oscillator, a multivibrator, and/or any other mechanism whereby a periodic wave and/or bitstream associated with the passage of time may be maintained. In various instances, the frame clock 22 provides periodic interrupt triggers. In further instances, the frame clock 22 provides a square wave. The frame clock 22 may comprise any timekeeping mechanism. In various instances, and as mentioned previously, a “frame” may be associated with one or more samples of audio signal from input 4.

The audio energy detection controller 8 may comprise an input audio energy (IAE) measurement unit 24. An IAE measurement unit 24 may measure an energy of input audio received on the audio input 4 (FIG. 2). The energy measurement may comprise an RMS amplitude (rather than an instantaneous peak amplitude) and/or any other metric corresponding to the intensity of the input audio (e.g., the received sound pressure level at a microphone or other audio transducer). The IAE measurement unit 24 may measure an energy of input audio received on the audio input 4 (FIG. 2) for each of a plurality of samples of the input audio signal on the audio input 4. In various embodiments, one or more samples corresponds to a frame.

The IAE measurement unit 24 may generate a weighted energy value corresponding to the measured input audio energy of the plurality of samples. For example, the value of each of the samples may be averaged together. Calculations, such as a RMS value, mean, median, mode, or other means of weighting may be implemented. In this manner, anomalies, noise, outlier samples, and/or the like may be addressed through mathematical combination with other samples.

The audio energy detection controller 8 may comprise a trigger frames counter 26. A trigger frames counter may count a number of the plurality of samples of the input audio signal on the audio input 4. The frame clock 22 may generate a clock signal corresponding to a series of clock cycles, wherein each of the plurality of samples of the input audio signal correspond in time to an individual clock cycle of the series of clock cycles. In other instances, other mechanisms for timing the samples may be implemented. In response to the number of frames and/or samples reaching a preset target (e.g., “a configurable trigger frames target”) the audio energy detection controller 8 may conclude the collection of the plurality of samples. Also, the trigger frames counter 26 may communicate with the IAE measurement unit 24 so that the generating of the weighted energy value is responsive to the trigger frames counter 26 of the audio energy detection controller 8 indicating that the number of the plurality of samples of the input audio signal at least equals the configurable trigger frames target. In this manner, the sampling of the input audio signal may be said to be “triggered” by the trigger frames counter 26, because the trigger frames counter 26 determines the moment to end the sampling.

The audio energy detection controller 8 may include an input audio energy (IAE) comparison engine 21. The IAE comparison engine 21 receives the weighted energy value from the IAE measurement unit 24 and compares the weighted energy value to an IAE value threshold. The IAE value threshold may be a preset threshold, or may be a dynamic threshold calculated by the IAE comparison engine 21 and/or another component of the system 2 in conjunction with the IAE comparison engine 21. For instance, a dynamic threshold may be calculated based on an ambient noise floor and/or the like. The IAE comparison engine 21 directs, in response to the weighted energy value exceeding the IAE value threshold, a window status reporting module 25 to set a window status flag of a flag memory 14.

The audio energy detection controller 8 may include a window frames counter 28. The window frames counter may increment a window frames index, wherein each of the increments of the window frames counter 28 of the audio energy detection controller 8 correspond in time to an individual clock cycle of the series of clock cycles. The window frames counter 28 may thus count clock cycles for the purpose of determining the amount of time passed since the weighted energy value exceeded the IAE value threshold. The window frames counter thus may determine that the window frames index equals a preset target (e.g., “a configurable window length target”). In response to the window frames index equaling the configurable window length target, the window frames counter 28 may direct the window status reporting module 25 to unset the window status flag of the flag memory 14. In this manner, a time slot is defined beginning in response to the weighted energy value exceeding the IAE value threshold and ending in response to a period of time corresponding to the configurable window length target having elapsed since the weighted energy value exceeded the IAE value threshold. This timeslot is called a “configurable keyword detection window” which opens when the weighted energy value exceeds the IAE value threshold and closes when the configurable window length target has elapsed since the weighted energy value last exceeded the IAE value threshold. In various embodiments, each exceeding of the IAE value threshold resets the window frames index, such that the configurable keyword detection window slides forward in time.

Having discussed the audio energy detection controller 8, refer to FIGS. 1 and 2 for a more detailed discussion of the keyword detector 12. In various instances, the keyword detector may have various features. For example, the keyword detector 12 may detect a presence of a keyword contained in an input audio signal received on audio input 4. For example, the keyword detector 12 may determine if the input audio signal includes “Alexa” or “Hey Google” or “Hey Siri” or any other keyword as desired. The keyword detector 12 may generate a detected audio signature comprising a mathematical representation of characteristics of the input audio signal. For instance, the input audio signal contains both time domain and frequency domain aspects that can be quantified and measured. Different components of the signal may have different amplitudes at different frequencies and may vary over time in frequency and time domains. Different signals may have different energy spectral densities and different power spectral densities. A signature may be generated based on these different components and their characteristics.

In embodiments, keyword detector 12 may have or may access a single known keyword signature. In other embodiments, keyword detector 12 may have or may access a library of stored known keyword signatures called a known keyword signature set. The known keyword signatures correspond to the different components of a signal that has different amplitudes at different frequencies and may vary over time in frequency and time domains. The signature generated based on these different components and their characteristics may be compared to the detected audio signature and by identifying similarities, the detected audio signature may be predicted to represent a same word, phrase, or keyword as that of the known keyword signature. In various embodiments, a spectral coherence between a known signal and the input audio signal are compared. Based on the above mechanisms, as well as other mechanisms that a skilled artisan would understand, the keyword detector 12 may determine the presence or absence of a keyword in one or more sample of an input audio signal.

Consequently, detecting by the keyword detector 12, the presence of the keyword, may proceed in several steps. For example, the keyword detector 12 may detect an audio signature of a plurality of samples of input audio. The keyword detector 12 may then compare the audio signature to a known keyword signature set, as discussed above. The keyword detector 12 determines that the audio signature of the plurality of samples of the input audio corresponds to at least one known keyword signature of the known keyword signature set. It should be appreciated that keyword detector 12 may be implemented in many ways known to those skilled in the art, and that the present embodiments are not limited to any particular implementation, and so further details thereof will not be presented here for sake of clarity of the present embodiments.

In response to detecting a presence of a keyword contained in the input audio signal, the keyword detector 12 may transmit an interrupt trigger to a detection event reporter 16 to trigger an interrupt (e.g., a “keyword presence interrupt” of the detection event reporter 16 to indicate detecting the presence of the keyword.

Finally, having discussed both the audio energy detection controller 8 and the keyword detector 12, as well as the flag memory 14, the false wake abatement system 2 also includes a detection event reporter 16. The detection event reporter 16 comprises a data retrieval mechanism structured to access the flag memory 14 and read the values of contents of the flag memory 14. For example, the detection event reporter 16 may check the window status flag of the flag memory 14. The detection event reporter 16 may read the state of the window status flag. It is in this manner that the detection event reporter 16 learns whether the sliding configurable keyword detection window is open and thus a positive detection of the presence of a keyword may be indicated upon catching of an interrupt triggered by the keyword detector 12, or if the sliding configurable keyword detection window is closed so that a positive detection of the presence of a keyword shall not be permitted to be indicated, regardless of whether the keyword detector 12 triggers an interrupt. The detection event reporter 16 may include an interrupt input. The interrupt input may catch an input triggered by the keyword detector 12. Upon the catching of the keyword presence interrupt triggered by the keyword detector 12, the detection event reporter 16 may then access the flag memory 14 to determine if the keyword indicated by the keyword presence interrupt is temporally coincident with an open sliding configurable keyword detection window. Stated differently, the detection event reporter 16 may report a presence of the keyword in response to the window status flag being set and also the keyword presence interrupt being triggered.

The reporting may comprise setting a logic level high or low, or sending a particular data byte or bytes or otherwise providing an electronic indication via an event detection logic output 6. In various embodiments, the reporting by the detection event reporter 16 comprises sending an activation signal to a personal electronic device to end a sleep mode of the personal electronic device. The activation signal may comprise a logic level on a circuit connection, or may comprise a specific byte or bytes, or may comprise a logical function call within a software application, or may comprise any other mechanism to provide an electronic indication. In various instances, the audio energy detection controller 8, the keyboard detector 12, and/or the detection event reporter 16 are components of a smart microphone device. In some such embodiments, the smart microphone device wakes a personal electronic device, such as a smartphone.

While components of the keyword detector 12, the detection event reporter 16, and the audio energy detection controller 8 have been discussed separately, one may also understand that these components may operate simultaneously. For example, various aspects of the keyword detector 12, the detection event reporter 16, and the audio energy detection controller 8 may operate in parallel. For example, measuring, by the input audio energy (IAE) measurement unit 24 of the audio energy detection controller 8, of the input audio energy of each of the plurality of samples of the input audio signal may occur at least partially simultaneously with the detecting, by the keyword detector 12 the presence of the keyword contained in the input audio signal. In further instances, the keyword detector 12 is in a deactivated and/or low power state until the window status flag is set. Other configurations are also possible, as desired.

With reference to FIGS. 2 and 6, a method of false wake abatement 400 is illustrated in an example flow chart. Operations performed by the audio energy detection controller 8 (FIG. 2) are depicted as a method of input audio energy level thresholding 500, operations performed by the keyword detector 12 are depicted as a method of keyword detection 600, and operations performed by the detection event reporter 16 are depicted as a method of event reporting 700. The combination of the method of input audio energy level thresholding 500 and method of keyword detection 600, as well as the method of event reporting 700 may occur at least partially simultaneously and comprises the method of false wake abatement 400.

For example, an initial configuration of an audio energy detection controller 8 may be performed (block 510). The audio energy detection controller 8 may be configured in several ways. For example, the number of frames making up the sliding configurable keyword detection window may be configured. The number of frames making up the sampling window may be configured. The threshold associated with the amplitude exceeding a threshold may be set. Finally, the audio energy detection controller 8 may be set on or off. For instance, the audio energy detection controller 8 may be set to an off state so the window status flag is always set.

The input audio energy level (IAE) may be measured by the IAE measurement unit 24 as previously discussed (block 520). An IAE comparison engine 21 determines whether the measured IAE value exceeds an IAE value target (block 530). If not, the process returns to block 520. If so, then the window status flag is set so that the configurable keyword detection window is opened (block 540).

Referring to the method of keyword detection 600, a keyword detector 12 may check input audio sample(s) for the presence of a keyword (block 610). In response to a keyword detection by the keyword detector 12 (block 620), the keyword detector 12 triggers an interrupt caught by the detection event reporter 16 which begin a method of event reporting 700. The detection event reporter 16 evaluates whether the window status flag is set so that the configurable keyword detection window is determined to be in an opened status (block 410). For example, the detection event reporter 16 may read the flag memory 14 (FIG. 2) to retrieve the window status flag. In response to the window not being opened, the method of event reporting 700 halts at step 410 and the process returns to the method of keyword detection 600 resuming at block 610. In response to the window being open, the detection event reporter 16 reports the keyword detection event to an event detection logic output 6 (block 420).

As used herein, the singular terms “a,” “an,” and “the” may include plural references unless the context clearly dictates otherwise. Additionally, amounts, ratios, and other numerical values are sometimes presented herein in a range format. It is to be understood that such range format is used for convenience and brevity and should be understood flexibly to include numerical values explicitly specified as limits of a range, but also to include all individual numerical values or sub-ranges encompassed within that range as if each numerical value and sub-range is explicitly specified.

While the present disclosure has been described and illustrated with reference to specific embodiments thereof, these descriptions and illustrations do not limit the present disclosure. It should be understood by those skilled in the art that various changes may be made and equivalents may be substituted without departing from the true spirit and scope of the present disclosure as defined by the appended claims. The illustrations may not be necessarily drawn to scale. There may be distinctions between the artistic renditions in the present disclosure and the actual apparatus due to manufacturing processes and tolerances. There may be other embodiments of the present disclosure which are not specifically illustrated. The specification and drawings are to be regarded as illustrative rather than restrictive. Modifications may be made to adapt a particular situation, material, composition of matter, method, or process to the objective, spirit and scope of the present disclosure. All such modifications are intended to be within the scope of the claims appended hereto. While the methods disclosed herein have been described with reference to particular operations performed in a particular order, it will be understood that these operations may be combined, sub-divided, or re-ordered to form an equivalent method without departing from the teachings of the present disclosure. Accordingly, unless specifically indicated herein, the order and grouping of the operations are not limitations of the present disclosure.

What is claimed is:

1. A method of false wake abatement comprising:
receiving, by an audio energy detection controller, an input audio signal;
measuring, by an input audio energy (TAB) measurement unit of the audio energy detection controller, an input audio energy of a plurality of samples of an input audio signal;
generating, by the IAE measurement unit, a weighted energy value corresponding to the measured input audio energy of the plurality of samples;
comparing, by an IAE comparison engine, the weighted energy value to an IAE value threshold; and
in response to the weighted energy value exceeding the IAE value threshold, directing, by the IAE comparison engine, a window status reporting module to set a window status flag of a flag memory.

2. The method of false awake abatement according to claim 1, further comprising:
receiving, by a keyword detector, the input audio signal;
detecting, by the keyword detector, a presence of a keyword contained in the input audio signal;
triggering by the keyword detector, a keyword presence interrupt of a detection event reporter, responsive to the detecting the presence of the keyword, to indicate the detecting the presence of the keyword;
retrieving, by the detection event reporter in response to the triggering the keyword presence interrupt, the window status flag of the flag memory;
accessing, by a detection event reporter, the retrieved window status flag in response to the triggering the keyword presence interrupt; and
reporting, by a detection event reporter, the presence of a keyword in response to the window status flag being set and the keyword presence interrupt being triggered.

3. The method of false wake abatement of claim 2, further comprising:
counting, by a trigger frames counter of the audio energy detection controller, a number of the plurality of samples of the input audio signal,
wherein a frame clock generates a clock signal comprising a series of clock cycles, wherein one or more of the plurality of samples of the input audio signal correspond in time to an individual clock cycle of the series of clock cycles, and
wherein the generating the weighted energy value is responsive to the trigger frames counter of the audio energy detection controller indicating that the number of the plurality of samples of the input audio signal at least equals a configurable trigger frames target.

4. The method of false wake abatement of claim 2,
wherein a frame clock generates a clock signal comprising a series of clock cycles;
incrementing, by a window frames counter of the audio energy detection controller, a window frames index, wherein each of the increments of the window frames counter of the audio energy detection controller correspond in time to an individual clock cycle of the series of clock cycles;
determining, by the window frames counter of the audio energy detection controller that the window frames index equals a configurable window length target; and
in response to the window frames index equaling the configurable window length target, unsetting the window status flag of the flag memory.

5. The method of false wake abatement of claim 2, wherein the detecting, by the keyword detector, the presence of the keyword, comprises:
detecting an audio signature of a second plurality of samples of the input audio signal;
comparing the audio signature to a known keyword signature set; and
determining that the audio signature of the second plurality of samples of the input audio corresponds to at least one known keyword signature of the known keyword signature set.

6. The method of false wake abatement according to claim 2, wherein the (i) measuring, by the input audio energy (IAE) measurement unit of the audio energy detection controller, the input audio energy of the plurality of samples of the input audio signal occurs at least partially simultaneously with the (ii) detecting, by the keyword detector the presence of the keyword contained in the input audio signal.

7. The method of false wake abatement according to claim 2, wherein the reporting, by the detection event reporter, comprises sending an activation signal to a personal electronic device to end a sleep mode of the personal electronic device.

8. A non-transient computer readable medium containing program instructions for causing a computer to perform a method of false wake abatement comprising:
receiving, by an audio energy detection controller, an input audio signal;
measuring, by an input audio energy (TAB) measurement unit of the audio energy detection controller, an input audio energy of a plurality of samples of the input audio signal;
generating, by the IAE measurement unit, a weighted energy value corresponding to the measured input audio energy of the plurality of samples;
comparing, by an IAE comparison engine, the weighted energy value to an IAE value threshold;
in response to the weighted energy value exceeding the IAE value threshold, directing, by the IAE comparison engine, a window status reporting module to set a window status flag of a flag memory.

9. The non-transient computer readable medium of claim 8, containing program instructions for causing the computer to perform the method of false wake abatement further comprising:
receiving, by a keyword detector, an input audio signal;
detecting, by the keyword detector, a presence of a keyword contained in the input audio signal;
triggering by the keyword detector, a keyword presence interrupt of a detection event reporter, responsive to the detecting the presence of the keyword, to indicate the detecting the presence of the keyword;
retrieving, by detection event reporter, the window status flag of the flag memory, in response to the triggering the keyword presence interrupt;
accessing, by a detection event reporter, the retrieved window status flag, in response to the triggering the keyword presence interrupt; and
reporting, by a detection event reporter, the presence of the keyword in response to the keyword presence interrupt being set and the window status flag being triggered.

10. The non-transient computer readable medium of claim 9, containing program instructions for causing the computer to perform the method of false wake abatement further comprising:
counting, by a trigger frames counter of the audio energy detection controller, a number of the plurality of samples of the input audio signal,
wherein a frame clock generates a clock signal comprising a series of clock cycles, wherein one or more of the plurality of samples of the input audio signal correspond in time to an individual clock cycle of the series of clock cycles, and
wherein the generating the weighted energy value is responsive to the trigger frames counter of the audio energy detection controller indicating that the number of the plurality of samples of the input audio signal at least equals a configurable trigger frames target.

11. The non-transient computer readable medium of claim 9, containing program instructions for causing the computer to perform the method of false wake abatement further comprising:
incrementing, by a window frames counter of the audio energy detection controller, a window frames index, wherein each of the increments of the window frames counter of the audio energy detection controller correspond in time to an individual clock cycle of a series of clock cycles,
wherein a frame clock generates a clock signal comprising the series of clock cycles;
determining, by the window frames counter of the audio energy detection controller that the window frames index equals a configurable window length target; and
in response to the window frames index equaling the configurable window length target, unsetting the window status flag of the flag memory.

12. The non-transient computer readable medium of claim 9, containing program instructions for causing the computer to perform the method of false wake abatement,
wherein the detecting, by the keyword detector the presence of the keyword comprises:
detecting an audio signature of a second plurality of samples of the input audio;
comparing the audio signature to a known keyword signature set; and
determining that the audio signature of the second plurality of samples of the input audio corresponds to at least one known keyword signature of the known keyword signature set.

13. The non-transient computer readable medium of claim 9, containing program instructions for causing the computer to perform the method of false wake abatement, wherein the (i) measuring, by the input audio energy (IAE) measurement unit of the audio energy detection controller, the input audio energy of the plurality of samples of the input audio signal occurs at least partially simultaneously with the (ii) detecting, by the keyword detector the presence of the keyword contained in the input audio signal.

14. The non-transient computer readable medium of claim 9, containing program instructions for causing the computer to perform the method of false wake abatement, wherein the reporting, by the detection event reporter, comprises sending an activation signal to a personal electronic device to end a sleep mode of the personal electronic device.

15. A system for false wake abatement comprising:
an audio energy detection controller connected to an audio input and configured to receive an input audio signal from the audio input and store a window status flag in a flag memory in response to the input audio signal;
a keyword detector connected to the audio input and configured to receive the input audio signal from the audio input and to receive a window status flag from the flag memory and connected to a detection event reporter configured to indicate on an event detection logic output a presence of a keyword; and
the detection event reporter connected to the flag memory and the keyword detector;
wherein the audio energy detection controller comprises:
an input audio energy (IAE) measurement unit configured to measure an input audio energy of a plurality of samples of the input audio signal and configured to generate a weighted energy value corresponding to the measured input audio energy of the plurality of samples;
an IAE comparison engine configured to compare the weighted energy value to an IAE value threshold,
wherein, in response to the weighted energy value exceeding the IAE value threshold, the IAE comparison engine directs a window status reporting module to set a window status flag of a flag memory;
wherein the keyword detector detects a presence of the keyword contained in the input audio signal and triggers a keyword presence interrupt of the detection event reporter, responsive to the detecting the presence of the keyword, to indicate the detecting the presence of the keyword;
wherein the detection event reporter is configured to access the window status flag in response to the triggering the keyword presence interrupt and is configured to report the presence of the keyword in response to the window status flag being set and the keyword presence interrupt being triggered.

16. The system of false wake abatement of claim 15, wherein the audio energy detection controller further comprises:
a trigger frames counter configured to count a number of the plurality of samples of the input audio signal; and
a frame clock configured to generate a clock signal comprising a series of clock cycles, wherein each of the plurality of samples of the input audio signal correspond in time to an individual clock cycle of the series of clock cycles,
wherein the generating the weighted energy value is responsive to the trigger frames counter of the audio energy detection controller indicating that the number of the plurality of samples of the input audio signal at least equals a configurable trigger frames target.

17. The system of false wake abatement of claim 15, wherein the audio energy detection controller further comprises:
a frame clock configured to generate a clock signal comprising a series of clock cycles; and
a window frames counter configured to increment a window frames index, wherein each of the increments of the window frames counter correspond in time to an individual clock cycle of the series of clock cycles,
wherein the window frames counter is further configured to determine that the window frames index equals a configurable window length target, and
wherein in response to the window frames index equaling the configurable window length target, the window status flag of the flag memory is unset.

18. The system of false wake abatement of claim 15, wherein the keyword detector detects the presence of the keyword by at least:
detecting an audio signature of a second plurality of samples of the input audio signal;
comparing the audio signature to a known keyword signature set; and
determining that the audio signature of the second plurality of samples of the input audio corresponds to at least one known keyword signature of the known keyword signature set.

19. The system of false wake abatement according to claim 15, wherein the input audio energy (IAE) measurement unit of the audio energy detection controller measures the input audio energy of the plurality of samples of the input audio signal at least partially simultaneously with the keyword detector detecting the presence of the keyword contained in the input audio signal.

20. The system of false wake abatement according to claim 15, wherein the detection event reporter sends an activation signal to a personal electronic device to end a sleep mode of the personal electronic device.
